(19) United States
(12) Patent Application Publication
(10) Pub. No.: US 2004/0045202 A1
(43) Pub. Date: Mar. 11, 2004

(54) Package labeling for a nutritionally enhanced composite food product

(76) Inventors: Thomas A. Arrendale III, Baldwin, GA (US); Chester L. Crum JR., St. Petersburg, FL (US)

Correspondence Address: JINAN GLASGOW, P O BOX 28539, RALEIGH, NC, 276118539

(21) Appl. No.: 10/237,644

(22) Filed: Sep. 9, 2002

(51) Int. Cl. G09F 23/00

(52) U.S. Cl. 40/637

(57) ABSTRACT

Package labeling for a nutritionally-enhanced composite food product for providing a predictable nutrient amount, including at least one serving element, a serving element composed of a first carrier meat and a second nutritionally enhanced foodstuff distinct from the first carrier meat; the first carrier meat having at least one predetermined dimension providing a portion size for providing predictable nutrient levels of the composite food product; the nutritional claims made to the nutritionally enhanced foodstuff, including at least one nutritional enhancer, for inclusion on packaging and/or labeling.

### BACKGROUND OF THE INVENTION

(1) Field of the Invention

The present invention relates generally to food products and, more particularly, to a nutritionally enhanced composite food product.

(2) Description of the Prior Art

Advancements in the area of nutrition has led to the recognition of the need for supplementing diets with various nutrients, including vitamins, minerals, essential fatty acids, and the like. Many persons consume large amounts of these nutrients in the form of pills, tablets, and liquids. However, taking the large amount of nutrients in this manner is annoying and frequently forgotten, thus returning the person to a state of malnourishment. Therefore, a better way of delivering nutrients to persons is needed. Fortification of foods is another way of delivering nutrients. Fortification of bread with vitamins is even mandated by the US Federal government. Additionally, the USDA carefully restricts food product labeling for meats and has heretofore not permitted nutrition claims on meat products. However, over-consumption of certain nutrients can occur, if the consumer is not aware of the fortification level of foods. Calcium over-consumption has been suggested to occur, especially in men, due to the increased level of calcium in calcium-fortified foods. Meats, which are an excellent source of protein and part of most diets, could be fortified with various nutrients. However, government regulatory agencies, specifically the USDA, currently prohibit the nutritional fortification of meats directly. Such products can not be labeled as fortified, nor the fortifying nutrients described on the label, and as such, the consumers could not make informed decisions regarding such a product within the context of a nutritionally balanced diet. Thus a need exists for a nutritionally-enhanced composite meat product with corresponding nutritional labeling on its packaging so that a consumer can make informed choices regarding the product within the context of a balanced diet.

### SUMMARY OF THE INVENTION

The present invention is directed to package labeling for a nutritionally enhanced composite food product including a first core or carrier meat with a substantially consistent size and a second nutritionally enhanced foodstuff combined with but distinct from the carrier meat such that the nutritional value of the composite food product is substantially equal to a target value, the nutritional claims directed to the nutritionally enhance foodstuff component that is distinct from the first carrier meat.

The present invention is further directed to package labeling for a nutritionally enhanced composite meat product including a first core or carrier meat with a substantially consistent size and a second nutritionally enhanced foodstuff combined with but distinct from the carrier meat such that the nutritional value of the composite meat product is substantially equal to a target value, the nutritional claims directed to the nutritionally enhance foodstuff component that is distinct from the first carrier meat.

### BRIEF DESCRIPTION OF THE DRAWINGS

FIG. 1 is a sample label with front and back sides identified.

### DETAILED DESCRIPTION OF THE PREFERRED EMBODIMENTS

In the following description, like reference characters designate like or corresponding parts throughout the several views. Also in the following description, it is to be understood that such terms as “forward,” “rearward,” “front,” “back,” “right,” “left,” “upwardly,” “downwardly,” and the like are words of convenience and are not to be construed as limiting terms.

As used within this application, the term “stratified” is used to indicate a separate and distinct component that exists separately without intermixing with another component, which may be layered, e.g., a coating layer is applied onto a carrier layer or component, and the like, which remains separate and distinct without mixing with each other. Also, as used within this application, the term “composite” is used to indicate a structure or product made up of distinct components to form a complex product in which two or more distinct, complementary food substances or components, specifically a meat component and a foodstuff component with at least one nutritional enhancer or additive, are combined without mixing to produce properties in the overall combined product that are not present in either of the two separate components independently.

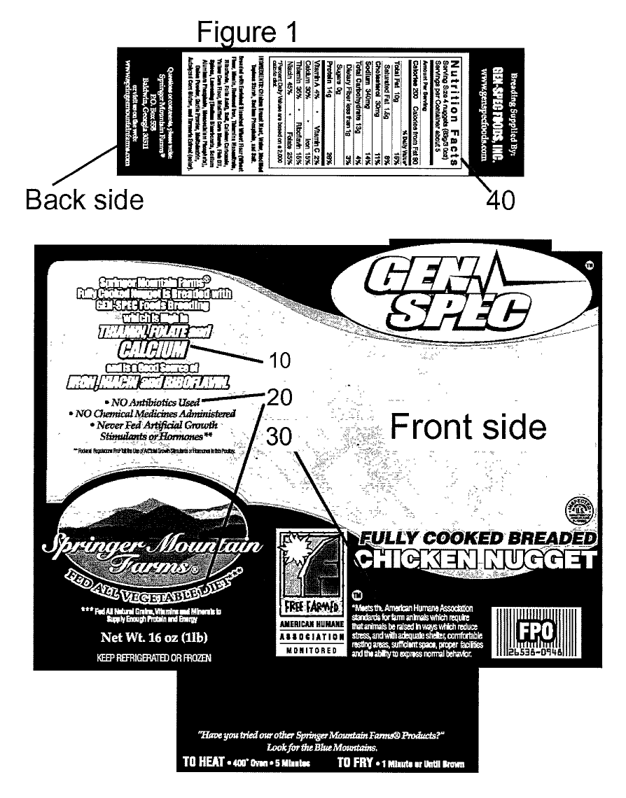

Packaging labeling of foodstuffs can be divided into nutrition facts and nutrition claims, components, and/or indications, as shown generally in FIG. 1. Nutrition facts are mandated by government regulations and are composed of a table, usually not prominently displayed, such as on the back or side of the package, which includes such nutrition facts as serving size, servings per container, calories/serving, calories from fat/serving, cholesterol/serving, sodium/serving, potassium/serving, carbohydrates/serving, protein/serving, and vitamins/serving. The nutrition facts indicate the amount and/or % daily values of each component per serving.

Nutrition claims, components, and/or indications are more prominently displayed, usually on the front of the package, and describe particular attributes of the foodstuff that the consumer might find appealing, such as “Low Fat”, “Calcium-Enriched”, “Good Source of Iron, Riboflavin, Niacin, Folate and CALCIUM” or “100% RDI Folic Acid”. These nutrition claims, components, and/or indications are designed to instruct the consumer about specific attributes of the product, and do not necessarily need to convey the actual quantity of the identified nutrient or component in the foodstuff, although informing the consumer about the quantity of a nutrient in a nutritional claims, components, and/or indications is possible.

The present invention is thus directed to package labeling for a composite food product, the composite food product shown in FIG. 1, consisting of a first core, substrate, or carrier meat, to which a second nutritionally enhanced foodstuff, including at least one nutritional enhancer, wherein the foodstuff is stratified from the first carrier meat, i.e., the foodstuff and its at least one nutritional enhancer is combined with but exists separately therefrom without mixing therewith. A single unit of the carrier meat is an element, and each element has at least one predetermined dimension size that allows a predictable amount of the second nutritionally enhanced foodstuff to be combined with it, thus providing a predictable, controlled serving size to enable and ensure that the consumer is receiving a predictable amount of desired nutrients. The composite food product thus provides substantially equal serving sizes and substantially predictable serving sizes, thereby providing predictable nutrient levels and thus permitting the fortification of meats and nutritional claims to nutritional enhancers in the second nutritionally enhanced foodstuff be made on the packaging and/or labeling, generally referenced as 10. The nutrition claims/components/indications may also include endorsements by associations or individuals as to the nutritional value of the product, for example, a product low in saturated fat and cholesterol may be endorsed by the American Heart Association as promoting good cardiovascular health.

The carrier meat is preferably selected from any of a variety of meats, including, but not limited to chicken, turkey, beef, lamb, pork, fish, shellfish, and the like. Additionally, the label preferably indicates a first nutritional claim 20 directed to whether the meat is from animals raised under special conditions to reduce the risk of disease or toxin transmission to humans, such as antibiotic-free, using organic feeds, using all-vegetable diets, and/or without the use of stimulants and hormone.

Such meats are stereotypically considered to be preferred by health-conscious consumers as well as animal rights advocates. Furthermore, the label also preferably indicates a second nutritional claim 30 directed to whether the animals are raised in a low stress environment in ways which reduce stress, and with adequate shelter, comfortable resting areas, sufficient space, proper facilities, and the ability to express normal behavior.

The meat is preferably fully cooked, such that the food product does not require lengthy preparation and there is less risk of microbial spoilage; however, in an alternate embodiment, the composite food product may be partially cooked or uncooked.

The nutritionally enhanced composite food product includes a second nutritionally enhanced foodstuff including at least one nutritional enhancer combined, mixed, incorporated, or integrated therewith. The second foodstuff is fortified with at least one nutritional enhancer and is combined with the meat carrier so that the second foodstuff and its at least one nutritional enhancer are maintained separate and distinct from the first meat carrier, i.e., no intermixing occurs between the meat carrier and the added foodstuff with its at least one nutritional enhancer. Nutritional fortification applies only to the second foodstuff. The second foodstuff is distinct from the first carrier meat component, and may be layered therewith, e.g., in the form of an exterior or interior application of the foodstuff onto or into the meat carrier, respectively. The second foodstuff can be on the exterior of the core meat component, such as a coating or breading. Where the foodstuff is located on the exterior surface of the meat component, the foodstuff may be applied onto the meat either before it is cooked or afterward, where the meat is fully or partially cooked prior to packaging and distribution. Alternatively or additionally, the second foodstuff can be in the interior of the first meat component, i.e., the second foodstuff is surrounded by the meat carrier or component. By way of example and not limitation, the second foodstuff may be wrapped with or injected into the carrier.

According to the present invention, nutritional enhancers or additives that are preferably used to fortify the second foodstuff include vitamins and minerals, such as calcium, iron, riboflavin, niacin, folate, thiamin, and the like, essential fatty acids, such as omega-3 and omega-6 fatty acids, amino acids, such as arginine; proteins, such as digestive enzymes, e.g., papain; and carbohydrates, such as glucosamine and chondroitin. In general, molecules that are essential nutrients or function as biomediators to influence the health and growth of the human body may be used as nutritional additives. The nutrients may be in their simplest chemical state, or chemically bound with other molecules. For example, essential fatty acids, such as docosahexaenoic acid, eicosapentaenoic acid, linolenic acid and linoleic acid, may be provided as such or as oils such as fish oil and/or flax seed oil.

The carrier meat has a predetermined dimension size that provides a predictable, controlled element size to enable and ensure that the consumer is receiving a predictable amount of desired nutrients. The composite food product thus provides substantially equal serving sizes and substantially predictable serving sizes, thereby providing predictable nutrient levels and thus permitting nutritional claims to be made to the product for inclusion on packaging and/or labeling.

The RDA values or similar federally regulated values or information includes the nutritional target level for the composite food product, which may be indicated on the package labeling. Additionally, nutrition facts 40, shown in FIG. 1, are required to be included on the package labeling on both a single serving basis, and, where applicable, to multiple servings that form the overall content of the package. As set forth hereinabove, the nutrition facts are generally listed on labeling for a back side of the package. Importantly, the present invention provides for nutrition claims, elements, and/or indications to be made, in addition to the nutrition facts, on the labeling for the package for a composite meat product. These nutrition claims, elements, and/or indications are preferably positioned on labeling located on a face or front side of the package, so that it is readily viewable by a consumer when the package is displayed for sale within a store or market. Previously, no nutritional claims were permitted for any meat product, since meat fortification is not permitted by the US government, specifically the USDA. However, importantly, the present invention properly provides for approved labeling for packaging for a composite meat product having nutritional claims that are directed to the nutritional enhancer and/or the nutritionally enhanced foodstuff component and not directly to the meat component itself. Since the fortification and nutritional enhancement of the composite meat product is made not to the meat component but to the nutritional enhancer(s) and/or to the nutritionally enhanced foodstuff, both of which are provided at predetermined levels for a serving size, the labeling according to the present invention includes nutritional claims that are based upon the purported, known, and/or proven benefits, characteristics, qualities, and/or features of the nutritional enhancer(s) and/or to the nutritionally enhanced foodstuff included in the composite meat product.

To achieve this RDA or similar federally regulated values or independent information that provide for the target level, the food product must have the first component having a predetermined, controllable target size and/or dimensions. The target size and/or dimensions include a 3D shape and/or a surface area or a target weight. By controlling the size and/or shape of the first core component, the amount of the second fortifying component can be added in a predictable, controllable manner for ensuring the predetermined nutritional characteristics of each unit or element, portion size, and/or serving size of the overall composite food product. For example, a nutritionally fortified composite food product consisting of a meat combined with a separate, distinct breading coverage according to the present invention is preferably made such that the amount of breading included in a single unit of the food product is substantially predictable and therefore the nutritional fortification provided by the breading to a single unit is substantially predictable. Thus the first core component must have minimum and maximum target sizes and tolerances, thereby ensuring proportional serving sizes for each unit or element. The food product may be packaged with single element or packaged with multiplicity of elements, which is correspondingly indicated on the package labeling. The nutritional claims provided on packaging of the composite food product based on a serving size are thus proportional to an element or unit, and correspond thereto. Nutritional claims are then made to the product on a per-serving basis, based on the quantity of the nutritionally enhanced foodstuff associated with a single serving of the product. Where a multiplicity of servings is provided within a given package, the nutrition facts may provide a corresponding element that provides for information on the total amount of nutrient levels within the entire package, as a multiple of the single serving of the product. Nutritional claims may also be made to the combined nutritional value of the carrier meat and the nutritionally enhanced foodstuff. A specific example follows:

In a preferred embodiment of the present invention, a carrier meat consisting of chicken breast meat is targeted to a unit weight of 83 grams +−5 grams. The first carrier thus sized is covered or coated with a second nutritionally enhanced breading fortified with niacin, iron, thiamine, riboflavin, folic acid, a calcium salt, and fish oil. Because a consistent amount of breading will adhere to the carrier meat so configured, each element provides 25%, 7.5%, 15%, 7.5% , 10%, and 10% of the US RDA for niacin, iron, thiamine, riboflavin, folic acid, and calcium, respectively, with the maximum difference from the target value of about 6% of the target value for each nutrient.

The amount, shape, and size of the first component varies depending upon the type of meat and type of meal to be provided, such as breakfast, lunch, dinner, or snack.

Thus, the package labeling for a nutritionally-enhanced meat product according to the present invention appropriately and properly includes nutritional claims since a serving size is proportional to an element size, which includes a predetermined, controllable amount of the fortified foodstuff component and/or nutritional enhancer with respect to a predetermined dimension and/or specification of a carrier meat that are separate and distinct from each other.

Either a single element or a multiplicity of elements within a package are both considered as preferable embodiments according to the present invention.

Certain modifications and improvements will occur to those skilled in the art upon a reading of the foregoing description. All modifications and improvements have been deleted herein for the sake of conciseness and readability but are properly within the scope of the following claims.

We claim:

1. A label for a package for a fortified composite food product having a first carrier meat component and a second fortified foodstuff component having at least one nutritional enhancer, the foodstuff combined with but distinct from the first carrier meat component and providing for at least one predetermined dimension providing a portion size for providing predictable nutrient levels of the composite food product, the label comprising nutritional claims directed to the fortified foodstuff component, thereby providing informational labeling for packaging of the composite food product.

2. The label according to claim 1, wherein the first carrier meat component has at least one predetermined dimension providing a portion size and a corresponding predetermined amount of for providing predictable nutrient levels.

3. The label according to claim 1 wherein the carrier meat is selected from the group consisting of chicken, turkey, beef, lamb, fish, shellfish, and pork.

4. The label according to claim 1, wherein the nutritional claims are directed to the at least one nutritional enhancer.

5. The label according to claim 1, wherein the second fortified foodstuff component is a coating.

6. The label according to claim 1, wherein the second fortified foodstuff component is a breading.

7. The label according to claim 1, wherein the nutritional claims include claims for combined nutritional values of the first carrier meat and second nutritionally enhanced foodstuff components.

8. The label according to claim 1, further including nutritional claims directed to the carrier meat component.

9. The label according to claim 9 wherein the nutritional claims are related to the diet of the animals from which the meat is derived.

10. The label according to claim 9 wherein the nutritional claims are related to the conditions in which the animals from which the meat is derived are raised.

11. The label according to claim 1, wherein the at least one nutritional enhancer is at least one nutritional additive selected from the group consisting of vitamins, minerals, fatty acids, carbohydrates, amino acids, proteins, and combinations thereof.

12. The label according to claim 11, wherein an amino acids are arginine.

13. The label according to claim 11, wherein the fatty acids are essential fatty acids.

14. The label according to claim 11, wherein the fatty acids are omega-3 fatty acids.

15. The label according to claim 11, wherein the fatty acids include a fish oil.

16. The label according to claim 11, wherein the fatty acids include a flax seed oil.

17. Packaging labeling for a nutritionally-enhanced composite meat product for providing a predictable nutrient amount, the composite meat product comprising at least one serving element, including a meat component, a foodstuff with at least one nutritional enhancer, the foodstuff being combined with but distinct from the meat component,
wherein the composite meat product provides at least one predetermined dimension providing a portion size for providing predictable nutrient levels,
the packaging labeling comprising nutritional claims directed to the at least one nutritional enhancer.
